(19) United States
(12) Patent Application Publication
(10) Pub. No.: US 2025/0039341 A1
(43) Pub. Date: Jan. 30, 2025

(54) Projection Apparatus and Method

(71) Applicant: Huawei Technologies Co., Ltd., Shenzhen (CN)

(72) Inventors: Kun Luo, Shenzhen (CN); Wei Xiong, Shenzhen (CN); Pengfei Zhao, Shenzhen (CN)

(21) Appl. No.: 18/809,861

(22) Filed: Aug. 20, 2024

Related U.S. Application Data
(63) Continuation of application No. PCT/CN2022/124862, filed on Oct. 12, 2022.

(30) Foreign Application Priority Data
Feb. 21, 2022 (CN) 202210157804.7

(51) Int. Cl. H04N 9/31

(52) U.S. Cl. CPC H04N 9/3135; H04N 9/3152; H04N 9/3164; H04N 9/3132

(57) ABSTRACT

A projection apparatus includes a pixel array disposed on a substrate, where the pixel array has a light-emitting feature; a cantilever beam disposed on the substrate and configured to fasten a micro-electro-mechanical system (MEMS) lens, where the cantilever beam is disposed outside the pixel array, the MEMS lens is configured to scan the pixel array, the cantilever beam and the MEMS lens form a MEMS lens scanner; and a driver coupled to the pixel array and the MEMS lens and configured to drive the pixel array having a light-emitting feature to perform color display to obtain a projected image.

### CROSS-REFERENCE TO RELATED APPLICATION

This is a continuation of International Patent Application No. PCT/CN2022/124862 filed on Oct. 12, 2022, which claims priority to Chinese Patent Application No. 202210157804.7 filed on Feb. 21, 2022. The disclosures of the aforementioned applications are hereby incorporated by reference in their entireties.

### TECHNICAL FIELD

This application relates to the field of projection display technologies, and in particular, to a projection apparatus and method.

### BACKGROUND

With continuous development of projection technologies and application of projection apparatuses in more fields, requirements of users for the projection technologies are also increasing. To adapt to more application scenarios, for example, application in the field of artificial intelligence (AI) and the field of virtual reality (VR) technologies, performance of the projection apparatus needs to be improved in terms of optimizing a size, increasing resolution, and the like.

In other approaches, to increase resolution of a projected image, a large optical module is generally used in the projection apparatus, resulting in a large size of the projection apparatus. In some other approaches, to achieve an effect of reducing a size of the projection apparatus, resolution is sacrificed to a specific extent, resulting in a problem of low resolution of a projected image.

### SUMMARY

This application provides a projection apparatus and method, to enable a small-sized projection apparatus to provide a higher-resolution projected image, and achieve an objective of optimizing a size and increasing resolution.

According to a first aspect, an embodiment of this application provides a projection apparatus, including a pixel array disposed on a substrate, where the pixel array has a light-emitting feature, a cantilever beam disposed on the substrate and configured to fasten a micro-electro-mechanical system (MEMS) lens, where the cantilever beam is disposed outside the pixel array, the MEMS lens is configured to scan the pixel array, and the cantilever beam and the MEMS lens form a MEMS lens scanner, and a driver connected to the pixel array and the MEMS lens scanner and configured to drive the pixel array having a light-emitting feature to perform color display, where the driver is further configured to control the MEMS lens to rotate on the cantilever beam and scan the color-display pixel array, to obtain a projected image.

In some examples, the pixel array includes a plurality of pixel blocks. For example, the pixel array may be a rectangular pixel array including M*N pixel blocks with M pixel blocks in each row and N pixel blocks in each column. Each pixel block includes three subpixels: red, green, and blue (RGB) subpixels. The subpixels have a light-emitting feature. M≥1, N≥1, and M*N>1. In some scenarios in which a circular pixel array, a trapezoidal pixel array, or another pixel array is required, the pixel array may also be set to another shape, and is not limited to a rectangle.

In some examples, an optical element such as a lens may be disposed on an optical path for projection imaging of the projection apparatus. For example, an optical element such as a lens is disposed between the pixel array and the projected image obtained through projection, to improve an imaging effect of the projected image.

The pixel array is disposed on the substrate of the projection apparatus, and the pixel array may display different colors under different drive signals. For example, the pixel array includes M*N pixel blocks, where M≥1, N≥1, and M*N>1. Each pixel block includes three primary colors: red, green, and blue. Different colors are displayed under different drive signals of the driver. For example, different electrical signals are used to drive the pixel blocks to emit light and display different colors. The MEMS lens that rotates on the cantilever beam scans the color-display pixel array back and forth along a track at different angles under control of the driver, to obtain scanned image blocks. The MEMS lens scans the pixel array for a plurality of times, to obtain image blocks at different positions of the projected image. The image blocks may be combined to form a frame of a complete projected image.

In a possible implementation, the driver is configured to, in a same timing, control the MEMS lens scanner to perform scanning, and drive the pixel array to perform color display.

The projection apparatus may obtain, based on data processing on an image that needs to be projected, a drive signal that can be used to drive the pixel array to perform color display and control the MEMS lens scanner to rotate along a track. In this way, in a same timing, based on a calculation result, the pixel array is driven to perform color display, and the MEMS lens is controlled to rotate, to further obtain a plurality of image blocks that can be combined into a complete projected image. In this method of combining a plurality of high-resolution image blocks to obtain a projected image, a large-sized optical module and component are not required, and a driving speed or a control speed of the driver does not need to be constantly increased to improve resolution. Based on a requirement of a data processing result, the pixel array having a light-emitting feature is driven and the MEMS lens scanner that performs multi-angle scanning is controlled, so that an effect of projecting a high-resolution projected image by a small-sized projection apparatus can be achieved.

In a possible implementation, the MEMS lens scanner is a one-dimensional (1D) lens scanner, and the driver is configured to control the MEMS lens to rotate along the cantilever beam within a first angle and scan the color-display pixel array, to obtain first image blocks obtained through scanning by the MEMS lens at a group of sampling time points, where the first image blocks at the group of sampling points form the projected image.

For example, the MEMS lens scanner is a 1D lens scanner, and the 1D lens scanner may perform rapid transverse scanning within the first angle, for example, within ±50 degrees. The driver controls the MEMS lens to rotate along the cantilever beam within ±50 degrees, to correspondingly obtain a plurality of image blocks, denoted as the first image blocks, at the group of sampling time points. The projection apparatus may determine the group of sampling time points on a selection basis that the plurality of first image blocks can be combined to obtain a frame of projected image. In other words, the plurality of first image blocks obtained at the sampling time points can be combined to obtain at least one frame of projected image. Alternatively, the group of sampling time points may be determined based on first image blocks combined to obtain a plurality of frames of projected images. The first angle may be determined based on an actual requirement. For example, the first angle may alternatively be set to +90 degrees.

In a possible implementation, the MEMS lens scanner is a two-dimensional (2D) lens scanner, and the driver is configured to control a MEMS lens in one dimension to rotate along the cantilever beam within a second angle and scan the color-display pixel array, to obtain second image blocks obtained through scanning by the MEMS lens at a group of sampling time points, and control a MEMS lens in the other dimension to rotate in a direction perpendicular to the cantilever beam within a third angle and scan the color-display pixel array, to obtain third image blocks obtained through scanning by the MEMS lens at another group of sampling time points, where the second image blocks and the third image blocks form the projected image.

For example, the MEMS lens scanner is a 2D lens scanner, and the 2D lens scanner may perform scanning in two directions. Based on different scanning modes, two axes may be generally classified into a fast axis and a slow axis. The lens scanner in one dimension may perform rapid transverse scanning along the cantilever beam within the second angle, for example, within ±50 degrees, to obtain a plurality of second image blocks at the group of sampling time points. The MEMS lens in the other dimension may perform slow vertical scanning in a direction perpendicular to the cantilever beam within 10 degrees, to obtain a plurality of third image blocks at the other group of sampling time points. Similarly, the two groups of sampling time points are determined on a selection basis that the obtained plurality of second image blocks and third image blocks can be combined to obtain a frame of projected image. In other words, the plurality of second image blocks and third image blocks obtained at the two groups of sampling time points can be combined to obtain at least one frame of projected image. Alternatively, the sampling time points may be determined based on second image blocks and third image blocks that are combined to obtain multiple frames of projected images. The second angle may alternatively be determined based on an actual requirement, and is not limited to +10 degrees.

In some examples, the driver may drive the MEMS lens scanner through logic control, to control the MEMS lens to rotate, or may control, in another driving manner, the MEMS lens to rotate and scan the color-display pixel array, to obtain a scanned image.

In a possible implementation, the pixel array includes a plurality of pixel blocks, and the pixel block includes: red, green, and blue subpixels that are disposed in parallel on a horizontal plane and that have a light-emitting feature, or red, green, and blue subpixels that are disposed in a stacked manner in a vertical direction and that have a light-emitting feature.

One pixel block may include three subpixels: red, green, and blue subpixels that are disposed in parallel on a horizontal plane. Alternatively, one pixel block includes three subpixels: red, green, and blue subpixels that are disposed in a stacked manner in a vertical direction. In other words, the three subpixels disposed in parallel on the horizontal plane may be disposed horizontally like subpixels disposed horizontally on a liquid crystal display screen. The three subpixels that are disposed in the stacked manner in the vertical direction are vertically arranged in a depth direction. From a perspective of a top view direction, the three subpixels overlap each other. A sequence of red, green, and blue may be adjusted as required, and is not limited to the sequence of red, green, and blue. In addition, a proper distance is maintained between the three subpixels: red, green, and blue subpixels. For example, the red, green, and blue subpixels are arranged based on a general pixel arrangement distance of the liquid crystal display screen.

In a possible implementation, an optical structure is disposed on a surface of the pixel array, where the optical structure is configured to calibrate emitted light of the pixel array to emitted light featured by a narrow beam and high collimation.

The optical structure may be a distributed Bragg reflector (DBR) structure, a micro lens structure, or the like. These optical structures can reduce a light emitting angle of the pixel array as much as possible, so that a beam emitted by the pixel array is featured by a narrow beam and high collimation.

In a possible implementation, the pixel array is a micro light-emitting diode (LED) display array or a micro organic LED (OLED) display array.

A micro LED technology is an LED miniaturization and matrix technology, and means that in a high-density and small-sized LED array integrated on a chip, each subpixel can be independently driven. A micro OLED technology is an OLED miniaturization and matrix technology, and each subpixel may also be independently driven. Therefore, the technologies are applicable to the projection apparatus provided in this application. Independently driven by the driver, each subpixel performs color display based on a drive signal required by a digital processing result, so that each subpixel is scanned to obtain different image blocks of an image that needs to be projected, to further form a frame of a complete projected image.

In a possible implementation, a scanning track of the MEMS lens is that a start end of the scanning track does not extend an utmost edge of the pixel array scanned by the MEMS lens.

The scanning track of the MEMS lens may be in a plurality of forms such as up to down and left to right, provided that a plurality of image blocks can be obtained through scanning on the track of the MEMS lens to form a frame of a complete projected image. However, if the scanning track greatly extends the subpixel, a drive waste is caused, and imaging time is prolonged. Therefore, the scanning track may be set to a shortest track on a scanning path that can ensure imaging. In other words, a scanning start end does not extend a subpixel at the utmost edge of the pixel array. To further reduce a possibility that the scanning track greatly extends the subpixel, a termination end of the scanning track does not extend the utmost edge of the pixel array scanned by the MEMS lens.

According to a second aspect, an embodiment of this application provides a projection method, including driving a pixel array having a light-emitting feature to perform color display, and controlling a MEMS lens to rotate on a cantilever beam and scan the color-display pixel array, to obtain a projected image, where the cantilever beam is disposed outside the pixel array and is configured to fasten the MEMS lens, the MEMS lens is configured to scan the pixel array, and the cantilever beam and the MEMS lens form a MEMS lens scanner.

In a possible implementation, the MEMS lens scanner is a 1D lens scanner. The controlling a MEMS lens to rotate on a cantilever beam and scan the color-display pixel array, to obtain a projected image includes controlling the 1D MEMS lens to rotate along the cantilever beam within a first angle and scan the color-display pixel array, to obtain first image blocks obtained through scanning by the MEMS lens at a group of sampling time points, where the first image blocks at the group of sampling points form the projected image.

In a possible implementation, the MEMS lens scanner is a 2D lens scanner. The controlling a MEMS lens to rotate on a cantilever beam and scan the color-display pixel array, to obtain a projected image includes controlling a MEMS lens in one dimension to rotate along the cantilever beam within a second angle and scan the color-display pixel array, to obtain second image blocks obtained through scanning by the MEMS lens at a group of sampling time points, and controlling a MEMS lens in the other dimension to rotate in a direction perpendicular to the cantilever beam within a third angle and scan the color-display pixel array, to obtain third image blocks obtained through scanning by the MEMS lens at another group of sampling time points, where the second image blocks and the third image blocks form the projected image.

In a possible implementation, the driving a pixel array having a light-emitting feature to perform color display, and controlling a MEMS lens to rotate on a cantilever beam to scan the color-display pixel array, to obtain a projected image includes, in a same timing, driving the pixel array having a light-emitting feature to perform color display, and controlling the MEMS lens to rotate on the cantilever beam and scan the color-display pixel array, to obtain the projected image.

In a possible implementation, a scanning track of the MEMS lens is that a start end of the scanning track does not extend an utmost edge of the pixel array scanned by the MEMS lens.

In this method, the MEMS lens scanner scans the pixel array having a light-emitting feature at different angles, to obtain the projected image. The projected image obtained by using this method has high resolution and a good picture effect. In addition, both the MEMS lens scanner and the pixel array have a small size and are disposed in the projection apparatus. This can support projection of a small-sized projection apparatus, and achieve an objective of optimizing a size of the projection apparatus and increasing resolution of the projection apparatus.

### BRIEF DESCRIPTION OF DRAWINGS

To describe the technical solutions in some embodiments of this application more clearly, the following introduces the accompanying drawings for describing embodiments of this application. The accompanying drawings in the following descriptions show some embodiments of this application, and a person of ordinary skill in the art may derive other drawings from these accompanying drawings without creative efforts.

FIG. 1 is a top view of a projection apparatus according to an embodiment of this application;

FIG. 2 is a diagram of a structure of scanning an image by a projection apparatus;

FIG. 3 is a diagram of a moving track of a MEMS lens;

FIG. 4 is a diagram of scanning display of a projection apparatus according to an embodiment of this application;

FIG. 5 is a diagram of arrangement and distribution in a pixel block; and

FIG. 6 is a flowchart of a projection method according to an embodiment of this application.

### DESCRIPTION OF EMBODIMENTS

The following describes the technical solutions in embodiments of this application with reference to the accompanying drawings in embodiments of this application. The described embodiments are some but not all of embodiments of this application. All other embodiments obtained by a person of ordinary skill in the art based on embodiments of this application without creative efforts shall fall within the protection scope of this application.

The term “and/or” in this specification describes only an association relationship for describing associated objects and represents that three relationships may exist. For example, A and/or B may represent the following three cases: only A exists, both A and B exist, and only B exists.

In the descriptions of embodiments of this application, unless otherwise clearly specified and limited, the terms “first” and “second” are used only for description and cannot be understood as an indication or implication of relative importance. Unless otherwise specified or stated, the term “a plurality of” means two or more. The term “connection”, “fastening”, or the like should be understood in a broad sense. For example, “connection” may be a fixed connection, or may be a detachable connection, an integral connection, or an electrical connection, or may be a direct connection, or may be an indirect connection performed by using an intermediate medium. A person of ordinary skill in the art may understand specific meanings of the terms in this application based on specific cases.

In the descriptions of this specification, it should be understood that orientation words such as “above” and “below” described in embodiments of this application are described from the perspective shown in the accompanying drawings, and should not be understood as a limitation on embodiments of this application. In addition, in the context, it should be further understood that when it is mentioned that an element is connected “above” or “below” another element, the element can be directly connected “above” or “below” the other element, or may be indirectly connected “above” or “below” the other element by using an intermediate element.

In embodiments of this application, words such as “example” or “for example” are used to represent giving an example, an illustration, or a description. Any embodiment or design scheme described as “example” or “for example” in embodiments of this application should not be explained as being more preferred or having more advantages than another embodiment or design scheme. Further, the use of words such as “example” or “for example” is intended to present a related concept in a specific manner.

In the descriptions of embodiments of this application, unless otherwise stated, “a plurality of” means two or more than two. The following describes this application in detail with reference to the accompanying drawings and embodiments. It should be understood that the specific embodiments described herein are merely used to explain this application but are not intended to limit this application.

A projection apparatus provided in embodiments of this application may include an engineering projector, a cinema projector, a laser television, a home theater, an education projector, a portable micro projector, and the like, and may be deployed in different scenarios for use, for example, an indoor or outdoor scenario and a handheld or vehicle-mounted scenario, may be deployed on the water (for example, on a ship), or may be deployed in the air (for example, on an airplane and a satellite). With increasing maturity of a projection technology, the projection apparatus is installed in different devices, and is applicable to various application scenarios. For example, the projection apparatus may be widely applied to the AI field and the VR field, or is applicable to a projection device in telemedicine and a projection device in a smart grid, a projection device in transportation safety, a projection device in a smart city, a projection device in a smart home, and the like. In addition, the projection display apparatus may be placed on a horizontal plane, or may be hung on a roof by using a davit, or may be installed in another device that needs to perform projection for use. This is not limited in this application.

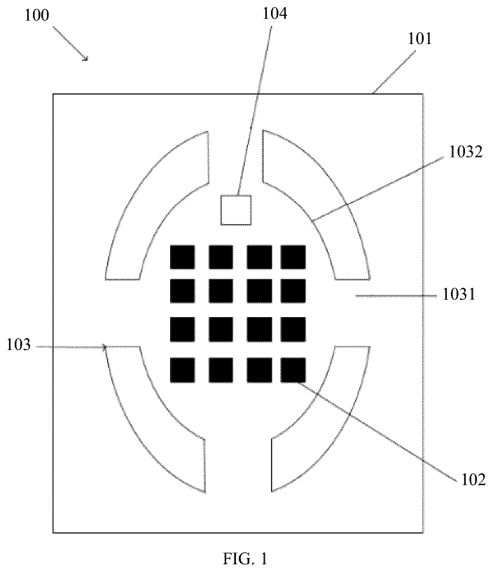

An embodiment of this application provides a projection apparatus. FIG. 1 is a top view of the projection apparatus according to this embodiment of this application. As shown in FIG. 1, the projection apparatus 100 includes a substrate 101, a pixel array 102, a MEMS lens scanner 103, and a driver 104. The MEMS lens scanner 103 includes a cantilever beam 1031 and a MEMS lens 1032.

In some examples, an optical element such as a lens may be disposed on an optical path for projection imaging of the projection apparatus 100. For example, an optical element such as a lens is disposed between the pixel array 102 and a projected image obtained through projection, to improve an imaging effect of the projected image.

The projection apparatus 100 includes the pixel array 102 disposed on the substrate 101, and the pixel array 102 has a light-emitting feature.

In some examples, the pixel array 102 may be a rectangular array including a plurality of pixel blocks, for example, including M pixel blocks 1021 in each row and N pixel blocks in each column, where M≥1, N≥1, and M*N>1. The pixel block includes subpixels having a light-emitting feature. In this application, an example in which the pixel array is a rectangular array is used for description. The pixel array may be set to different shapes based on different application scenarios, and the example of the rectangular array is not used as a limitation.

For example, each pixel block includes subpixels, which are generally subpixels with three primary colors, and may include, red, green, and blue subpixels. However, in a scenario that requires higher resolution, subpixels with more primary colors may be set.

The cantilever beam 1031 disposed on the substrate 101 is configured to fasten the MEMS lens 1032. The cantilever beam 1031 is disposed outside the pixel array 102. The MEMS lens 1032 is configured to scan the pixel array 102.

As shown in FIG. 1, the cantilever beam 1031 and the MEMS lens 1032 form the MEMS lens scanner 103.

The driver 104 connected to the pixel array 102 and the MEMS lens 1032 is configured to drive the pixel array 102 having a light-emitting feature to perform color display.

The driver 104 is further configured to control the MEMS lens 1032 to rotate on the cantilever beam 1031 and scan the color-display pixel array 102, to obtain a projected image.

A position of the driver 104 in FIG. 1 is merely an example. The position of the driver may be adjusted based on an actual requirement, and is not limited in this example. The driver only needs to be connected to the pixel array 102 and the MEMS lens scanner 103, and may transmit a drive signal to the pixel array 102 and the MEMS lens scanner 103, to drive the pixel array 102 to perform color display and control the MEMS lens scanner 103 to perform scanning, to obtain the projected image.

In some examples, the driver 104 may be a driver integrating a plurality of driving functions, for example, a driving function of an electrical signal for driving the pixel array to emit light and display, and a driving function of logically controlling a lens of the MEMS lens scanner to rotate to perform scanning and imaging. The driver 104 provided in this application may be a combination of a plurality of drivers or may integrate a plurality of functions, provided that the driver 104 can drive the pixel array to perform color display and can control the lens of the MEMS lens scanner to rotate to perform scanning and imaging. This is not limited to a specific driving manner.

In some other projection display technologies, because of features of technologies such as a liquid crystal on silicon (LCOS) technology, and a digital light processing (DLP) technology, projection imaging of the projection display technologies requires complex optical elements and systems such as backlight, a light source shaping system, and a prism. In this case, the projection apparatus has a large size, and cannot adapt to an operation scenario requiring a small size. In this application, the subpixels having a light-emitting feature are arranged as the pixel block, and the pixel array 102 including the pixel blocks is disposed on the substrate 101. A complex system is not required, and three primary colors (RGB) of red, green, and blue can be used as a display source. The MEMS lens 1032 that rotates around the cantilever beam 1031 scans, back and forth along a fixed track, the pixel array 102 that is driven by the same drive signal to perform color display, to respectively obtain a plurality of image blocks. The plurality of image blocks may form a frame of a complete projected image. This achieves an effect of scanning and imaging of a small-sized projection apparatus.

In current projection display technologies, there are some projection methods in which a laser projection display technology and reflected light of a MEMS lens scanner are used for imaging. However, in the method, resolution is low when a size of a projection apparatus is small, or a size of a required component and a size of a required optical module are correspondingly increased after the resolution is increased. In addition, a driver needs to perform driving at a high speed to ensure imaging, and use of the small-sized projection apparatus cannot be ensured. According to the projection apparatus in this application, to resolve the problem, the small-sized and high-resolution projection apparatus 100 applicable to projection is provided. The pixel array is disposed on the substrate 101 of the projection apparatus 100. The pixel array may display different colors under driving of the driver 104. In addition, driven by the driver 104, the MEMS lens 1032 that rotates on the cantilever beam 1031 scans the pixel array back and forth along a track at different angles, to obtain scanned image blocks. The image blocks form a frame of a complete projected image. The projection apparatus 100 only needs to obtain, based on data processing on an image that needs to be projected, a drive signal that can be used to drive the pixel array 102 to perform color display and an angle at which the MEMS lens scanner 103 is driven to rotate and perform scanning along the track. In this way, in a same timing, based on a requirement, the pixel array 102 is driven to perform color display, and the MEMS lens 1032 is controlled to rotate. Therefore, image blocks of the projected image are obtained. The image blocks are combined, and the projection device 100 can obtain a high-resolution projected image without a need of a large-sized optical module or component and without requiring the driver to perform driving at a high speed.

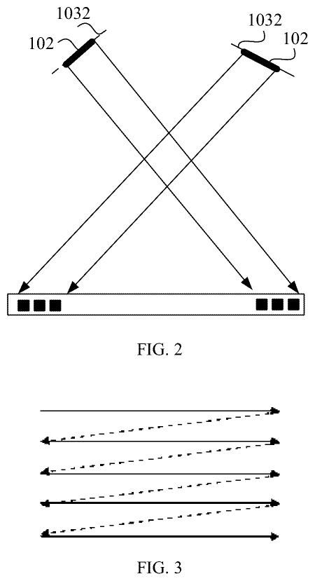

FIG. 2 is a diagram of a structure of scanning an image by the projection apparatus. As shown in FIG. 2, the projection apparatus 100 provided in this application controls the MEMS lens 1032 that rotates around the cantilever beam 1031, to enable the MEMS lens 1032 to rotate at a specific angle, in other words, move along a specific track, and scan the pixel array 102. The pixel array 102 is disposed at a front end of the MEMS lens 1032 and between the MEMS lens 1032 and a projection imaging position. The pixel array 102 may be attached to the MEMS lens 1032, as shown in FIG. 2, or may be fastened between the MEMS lens 1032 and the projection imaging position, provided that color display of the pixel array 102 can be performed to enable imaging to be performed at the projection imaging position with different angles at which the MEMS lens 1032 rotates. A specific position shown in FIG. 2 is not used as a limitation.

A moving track of the MEMS lens 1032 may be determined based on an image that needs to be imaged or the pixel array 102. For example, the moving track may be determined based on that a complete image that needs to be imaged can be obtained or that the pixel array 102 can be completely covered.

FIG. 3 is a diagram of the moving track of the MEMS lens. As shown in FIG. 3, if the MEMS lens 1032 rotates at the angle shown in FIG. 2 and performs scanning, in an example, rotates from a scanning position of the MEMS lens 1032 identified by a solid line in FIG. 2 to another scanning position of the MEMS lens 1032 identified by a dashed line, and then rotates from the position of the MEMS lens 1032 identified by the dashed line to the scanning position of the MEMS lens 1032 identified by the solid line, to repeatedly perform rotation and scanning, a scanning track formed is the moving track shown in FIG. 3. The MEMS lens 1032 repeatedly scans the pixel array 102 along the moving track, and projects different image blocks at different projection positions. The image blocks may be combined to obtain a frame of a complete projected image.

For example, in a process of using the projection apparatus 100, the projected image needs to be displayed. In this case, as shown in FIG. 3, the MEMS lens 1032 repeatedly scans, along a fixed scanning track, the pixel array 102 covered by the scanning track. FIG. 3 is merely used as an example, and the moving track of the MEMS lens 1032 is not limited to the scanning track.

It should be noted that the MEMS lens scanner 103 may be classified into a 1D lens scanner and a 2D lens scanner.

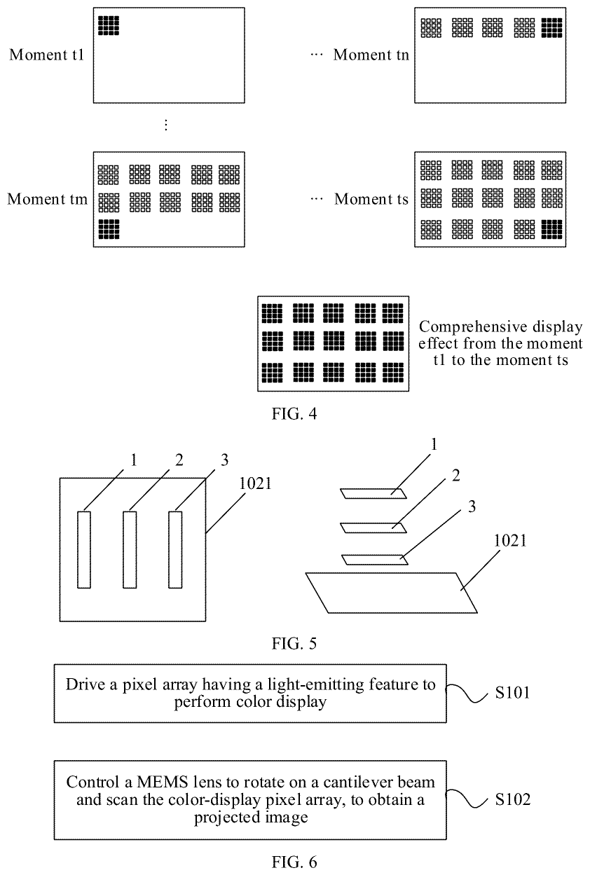

FIG. 4 is a diagram of scanning display of a projection apparatus according to an embodiment of this application. As shown in FIG. 4, the projection apparatus 100 obtains different image blocks at a group of sampling time points. Each image block corresponds to a part of a complete projected image. The image blocks may be combined to present a frame of the complete projected image.

In some examples, a MEMS lens scanner 103 is a 1D lens scanner. A driver 104 is configured to control a MEMS lens 1032 to rotate along a cantilever beam 1031 within a first angle and scan a color-display pixel array 102, to obtain first image blocks obtained through scanning by the MEMS lens 1032 at a group of sampling time points. The first image blocks at the group of sampling points form the projected image.

For example, the MEMS lens scanner 103 is a 1D lens scanner, and the 1D lens scanner may perform rapid transverse scanning. The first angle may be 50 degrees. The driver 104 controls the MEMS lens 1032 to rotate along the cantilever beam 1031 within ±50 degrees. As shown in FIG. 4, a plurality of first image blocks may be respectively obtained at groups of sampling time points from tl to tn and from tm to ts. A complete frame including all the first image blocks corresponding to the group of sampling time points is a frame of projected image that needs to be projected. The first angle herein may alternatively be set to 90 degrees, 30 degrees, or the like. This is not limited in the foregoing example.

Alternatively, a MEMS lens scanner 103 is a 2D lens scanner, and the 2D lens scanner may perform scanning in two directions. Based on different scanning modes, two axes may be generally classified into a fast axis and a slow axis. For example, it may be determined that the fast axis controls a MEMS lens 1032 in one dimension to rotate along a cantilever beam 1031, and the slow axis controls a MEMS lens 1032 in the other dimension to rotate in a direction perpendicular to the cantilever beam 1031.

A driver 104 is further configured to control the MEMS lens 1032 in one dimension to rotate along the cantilever beam 1031 within a second angle and scan a color-display pixel array, to obtain second image blocks obtained through scanning by the MEMS lens 1032 at a group of sampling time points, and control the MEMS lens 1032 in the other dimension to rotate in the direction perpendicular to the cantilever beam 1031 within a third angle and scan the color-display pixel array 102, to obtain third image blocks obtained through scanning by the MEMS lens 1032 at another group of sampling time points. The second image blocks and the third image blocks form the projected image.

In some examples, the driver 104 controls the MEMS lens 1032 in one dimension to rotate along the cantilever beam 1031 within ±50 degrees and scan the color-display pixel array, to obtain the second image blocks, for example, image blocks in a first row in FIG. 4, obtained through scanning by the MEMS lens 1032 at the group of sampling time points from tl to tn shown in FIG. 4. The driver 104 controls the MEMS lens 1032 in the other dimension to rotate in the direction perpendicular to the cantilever beam 1031 within ±10 degrees and scan the color-display pixel array, to obtain the third image blocks obtained through scanning by the MEMS lens 1032 at the group of sampling time points from tm to ts shown in FIG. 4. When scanning in both directions is completed, in an example, all the second image blocks and the third image blocks that correspond to the two groups of sampling time points are obtained, a frame of a complete projected image that needs to be projected may be formed. Time for forming a frame of a complete projected image is less than time for human eyes to distinguish image frame switching. Therefore, a user can normally use the projection apparatus to project and view a picture or a video, and user experience is not affected by combining the plurality of image blocks to obtain the projected image.

The second angle and the third angle in this example may alternatively be determined based on an actual scanning requirement, and are not limited to the foregoing example.

The projected image obtained based on the foregoing manner may provide a plurality of pieces of resolution based on an actual requirement. When a requirement for resolution of the projected image is high, the projected image can achieve high resolution. Both the 1D MEMS lens and the 2D MEMS lens have an adaptive application scenario. For example, in some AI or VR scenarios, the projection apparatus needs to be in a small size for adaptation. In this case, the projection apparatus may be configured with only the 1D MEMS lens. If the projection apparatus needs to provide a 480*640 projected image, and the pixel array is a 1*480 array, longitudinal resolution may be provided by color display of a longitudinal pixel array during each time of scanning, and horizontal resolution needs to be obtained by requiring the 1D MEMS lens scanner to scan 640 real pixels to support obtaining the projected image. Although this scanning manner requires to scan and sample more image blocks horizontally, a configuration of the projection apparatus is simpler, the resolution can also meet the requirement, and the scanning manner is applicable to a scenario with a low configuration requirement. A requirement for the resolution of the projected image and an arrangement manner of subpixels of the pixel array may be adjusted based on an actual requirement, and are not limited in this example.

The 2D MEMS lens scanner scans a same image to obtain projected images with same resolution. The scanning may be performed in two directions at the same time. Although a configuration is slightly more complex than that of the 1D MEMS lens scanner, the projected image can be obtained faster, and the 2D MEMS lens scanner is applicable to a scenario with a higher requirement for an imaging speed.

In some examples, the driver 104 is further configured to, in a same timing, control the MEMS lens scanner 103 to perform scanning, and drive the pixel array 102 to perform color display.

After data processing, information about an image that needs to be projected may be converted into two parts of drive signals. The driver 104 respectively outputs the two parts of drive signals. For example, a logic control signal is used to control the MEMS lens 1032 of the MEMS lens scanner 103, and an electrical signal is used to drive the pixel array 102 to perform color display. The two parts of drive signals need to ensure that, in the same timing, the MEMS lens scanner 103 is controlled and the pixel array 102 is driven. Ensuring real-time performance can ensure that color display of the pixel array 102 is consistent with scanning driving of the MEMS lens scanner 103, so that the projected image is displayed more accurately and a display effect is better.

Further, the pixel array 102 includes a plurality of pixel blocks 1021. FIG. 5 is a diagram of arrangement and distribution in the pixel block. As shown in FIG. 5, the pixel block 1021 includes: red, green, and blue subpixels that are disposed in parallel on a horizontal plane and that have a light-emitting feature, or red, green, and blue subpixels that are disposed in a stacked manner in a vertical direction and that have a light-emitting feature.

The red, green, and blue subpixels in the pixel block 1021 are respectively denoted as a red subpixel 1, a green subpixel 2, and a blue subpixel 3, and the three subpixels may be arranged in different forms. As shown in the left figure in FIG. 5, one pixel block may include three subpixels: red, green, and blue subpixels that are disposed in parallel on a horizontal plane. Alternatively, as shown in the right figure in FIG. 5, one pixel block includes three subpixels: red, green, and blue subpixels that are disposed in a stacked manner in a vertical direction.

For example, the three subpixels disposed in parallel on the horizontal plane may be disposed horizontally like subpixels disposed horizontally on a liquid crystal display screen. The three subpixels that are disposed in the stacked manner in the vertical direction are vertically arranged in a depth direction. From a perspective of a top view direction, the three subpixels overlap each other. A sequence of red, green, and blue may be adjusted as required, and is not limited to a sequence marked in the figure.

A proper distance is maintained between the three subpixels: red, green, and blue subpixels. For example, the red, green, and blue subpixels are arranged based on a general pixel arrangement distance of the liquid crystal display screen.

In some examples, the pixel array 102 is a micro LED array or a micro OLED array.

A micro LED technology is an LED miniaturization and matrix technology, and means that in a high-density and small-sized LED array integrated on a chip, each subpixel can be independently driven. A micro OLED technology is an OLED miniaturization and matrix technology, and each subpixel may also be independently driven. Therefore, the technologies are applicable to the projection apparatus provided in this application. Independently driven by the driver, each subpixel performs color display based on a drive signal required by a digital processing result, so that each subpixel is scanned to obtain different image blocks of an image that needs to be projected, to further form a frame of a complete projected image.

In some examples, the projection apparatus further includes an optical structure disposed on a surface of the pixel array 102. The optical structure is configured to calibrate emitted light of the pixel array to emitted light featured by a narrow beam and high collimation. The optical structure may be a DBR structure, a micro lens structure, or the like. These optical structures may reduce a light emitting angle of the micro LED pixel array or the micro OLED pixel array as much as possible, so that a beam emitted by the micro LED pixel array or the micro OLED pixel array is featured by a narrow beam and high collimation.

In some examples, a scanning track of the MEMS lens is that a start end of the scanning track does not extend an utmost edge of the pixel array scanned by the MEMS lens. As shown in the foregoing example, the scanning track of the MEMS lens may be in a plurality of forms such as up to down and left to right, provided that a plurality of image blocks can be obtained through scanning on the track of the MEMS lens to form a frame of a complete projected image. However, if the scanning track greatly extends the subpixel, a drive waste is caused, and imaging time is prolonged. Therefore, the scanning track may be set to a shortest track on a scanning path that can ensure imaging. In other words, a scanning start end does not extend a subpixel at the utmost edge of the pixel array. To further reduce a possibility that the scanning track greatly extends the subpixel, a termination end of the scanning track does not extend the subpixel at the utmost edge of the pixel array scanned by the MEMS lens.

In a possible manner, the pixel array in the projection apparatus provided in this embodiment of this application may be prepared on the MEMS lens. For example, the micro LED array or the micro OLED array may be prepared on the MEMS lens based on the foregoing example. The MEMS lens scanner may be a 1D lens scanner, namely, a lens scanner having a cantilever beam structure in one direction. Alternatively, the MEMS lens scanner may be a 2D lens scanner, namely, a lens scanner having cantilever beam structures in two directions perpendicular to each other.

The micro LED array or the micro OLED array has M*N pixel blocks, where M≥1, N≥1, and M*N>1. In the micro LED array or the micro OLED array, the pixel blocks are arranged and distributed with reference to the pixel arrangement distance in the liquid crystal display screen. In addition, RGB color subpixels of each pixel block may be arranged in different manners. For example, the RGB subpixels are separated on a plane, or the RGB subpixels are located in a same plane position, and are arranged in the stacked manner in sequence in the vertical direction. An arrangement manner of the subpixels is not limited in embodiments of this application.

During actual display, the MEMS lens repeatedly performs scanning along a fixed scanning track. The micro LED or the micro OLED integrated on a MEMS lens scanner performs corresponding color display in real time. In a scanning process of the MEMS lens, a plurality of image blocks is obtained one by one by properly driving the micro LED pixel array or the micro OLED pixel array. In a specific period of time, the image blocks are combined to finally form a 2D display picture, namely, the projected image.

In addition, to ensure feasibility of the entire solution, an optical structure may be prepared on a surface of the micro LED pixel array or the micro OLED pixel array, to reduce the light emitting angle of the micro LED or the micro OLED as much as possible, so that the beam emitted by the micro LED or the micro OLED is featured by a narrow beam and high collimation.

When the MEMS lens performs scanning along a fixed 2D scanning track, a finally formed effect is shown in FIG. 4. At the moment tl, the MEMS lens is at an angle, and the micro LED pixel array or the micro OLED pixel array is displayed in an upper left corner of a finally displayed picture. In a process in which the MEMS lens rotates along a horizontal direction at an angle, the micro LED pixel array or the micro OLED pixel array displays a picture at different positions of a to-be-displayed projected image, that is, display an image block. For example, at the moment tn, an image block is displayed at another position based on the previous image block.

In addition, when the MEMS lens rotates in a vertical direction by a specific angle, the micro LED pixel array or the micro OLED pixel array displays a picture at different vertical positions of the to-be-displayed projected image, as shown in the moment tm and the moment ts. Finally, from the moment tl to the moment ts, an entire 2D display picture may be formed, and a frame of projected image is correspondingly displayed. This process is repeated, and a plurality of frames of projected images may form a projected video or the like.

It should be noted that, for the projection apparatus with the micro LED or the micro OLED integrated on the MEMS, the 2D display picture that can be formed finally is the projected image. The displayed 2D picture may be analyzed, and an image processing method is optimized to obtain a more appropriate drive signal, to improve a display effect. The step may be performed during debugging of the projection apparatus. Alternatively, optimization and debugging may be performed by a built-in processor during use. This is not limited herein.

According to the projection apparatus provided in embodiments of this application, the pixel array having a light-emitting feature and the MEMS lens scanner that scans the array are driven to obtain the projected image. A high-resolution projected image can be obtained without a need of a large-sized optical module for providing a light source and without requiring the MEMS to be driven at a high speed. An image above a 1080P level can be projected under a condition that a projection apparatus is ensured to be smaller than 2 cubic centimeters. This resolves a problem in the other approaches that high resolution requires a large-sized projection device, and a small-sized projection device projects a low-resolution projected image.

An embodiment of this application provides a projection method. FIG. 6 is a flowchart of the projection method according to this embodiment of this application. The method includes the following steps.

S101: Drive a pixel array having a light-emitting feature to perform color display.

In some examples, the pixel array may be a rectangular pixel array including a plurality of pixel blocks, for example, including M pixel blocks in each row and N pixel blocks in each column. The pixel block includes three subpixels: red, green, and blue subpixels. The subpixels have a light-emitting feature. M≥1, N≥1, and M*N>1.

S102: Control a MEMS lens to rotate on a cantilever beam and scan the color-display pixel array, to obtain a projected image.

The cantilever beam is disposed outside the pixel array and is configured to fasten the MEMS lens. The MEMS lens is configured to scan the pixel array. The cantilever beam and the MEMS lens form a MEMS lens scanner.

S101 and S102 are performed in a same timing, and there is no sequence.

In some examples, the MEMS lens scanner is a 1D lens scanner. Controlling the MEMS lens to rotate on the cantilever beam and scan the color-display pixel array, to obtain the projected image includes controlling the 1D MEMS lens to rotate along the cantilever beam within a first angle and scan the color-display pixel array, to obtain first image blocks obtained through scanning by the MEMS lens at a group of sampling time points, where the first image blocks at the group of sampling points form the projected image.

In some examples, the MEMS lens scanner is a 2D lens scanner. Controlling the MEMS lens to rotate on the cantilever beam and scan the color-display pixel array, to obtain the projected image includes controlling a MEMS lens scanner in one dimension to rotate along the cantilever beam within a second angle and scan the color-display pixel array, to obtain second image blocks obtained through scanning by the MEMS lens at a group of sampling time points, and controlling a MEMS lens in the other dimension to rotate in a direction perpendicular to the cantilever beam within a third angle and scan the color-display pixel array, to obtain third image blocks obtained through scanning by the MEMS lens at another group of sampling time points, where the second image blocks and the third image blocks form the projected image.

Further, driving the pixel array having a light-emitting feature to perform color display, and controlling the MEMS lens to rotate on the cantilever beam and scan the color-display pixel array, to obtain the projected image may be, in a same timing, driving the pixel array having a light-emitting feature to perform color display, and controlling the MEMS lens to rotate on the cantilever beam and scan the color-display pixel array, to obtain the projected image. After data processing, information about a to-be-projected image may be output as two parts of drive signals. One signal is used to drive the MEMS lens to rotate and scan the color-display pixel array, to obtain the projected image, and the other signal is used to drive the pixel array to perform color display, for example, drive a micro LED array or a micro OLED array to perform color display. The two driving processes need to be performed in a same timing to ensure a display effect of the projected image.

In some examples, a scanning track of the MEMS lens is that a start end of the scanning track does not extend an utmost edge of the pixel array scanned by the MEMS lens. The scanning track of the MEMS lens is that a termination end of the scanning track does not extend the utmost edge of the pixel array scanned by the MEMS lens.

The method is applicable to image projection in the projection apparatus by using the method in the foregoing example of the projection apparatus, but is not limited to being applicable to the foregoing projection apparatus.

According to the projection apparatus and method provided in embodiments of this application, the pixel array having a light-emitting feature and the MEMS lens scanner that scans the array are driven to obtain the projected image. A high-resolution projected image can be obtained without a need of a large-sized optical module for providing a light source and without requiring the MEMS to be driven at a high speed. This enables a small-sized projection apparatus to provide a higher-resolution projected image, and achieves an objective of optimizing a size and increasing resolution.

A person skilled in the art should be aware that in the foregoing one or more examples, functions described in embodiments of this application may be implemented by hardware, software, firmware, or any combination thereof. When the functions are implemented by using the software, the functions may be stored in a computer-readable medium or transmitted as one or more instructions or code in a computer-readable medium. The computer-readable medium includes a computer storage medium and a communication medium. The communication medium includes any medium that facilitates transmission of a computer program from one place to another. The storage medium may be any available medium accessible to a general-purpose or dedicated computer.

The foregoing describes embodiments of this application with reference to the accompanying drawings. However, this application is not limited to the foregoing specific implementations. The foregoing specific implementations are merely examples, and are not limitative. Inspired by this application, a person of ordinary skill in the art may further make various forms without departing from the purposes of this application and the protection scope of the claims, and all the forms shall fall within the protection of this application.

1. An apparatus comprising:
a substrate;
a pixel array disposed on the substrate and comprising a light-emitting feature;
a micro-electro-mechanical system (MEMS) lens scanner comprising:
a MEMS lens configured to scan the pixel array; and
a cantilever beam disposed on the substrate and outside the pixel array and configured to fasten the MEMS lens; and
a driver coupled to the pixel array and the MEMS lens scanner and configured to:
drive the pixel array to perform color display; and
control the MEMS lens to rotate on the cantilever beam and scan the pixel array to obtain a projected image.

2. The apparatus of claim 1, wherein the MEMS lens scanner is a one-dimensional (1D) lens scanner, wherein the MEMS lens is further configured to further scan the pixel array at a group of sampling time points to obtain image blocks, wherein the image blocks form the projected image, and wherein the driver is further configured to further control the MEMS lens to rotate along the cantilever beam within an angle and scan the pixel array to obtain the image blocks.

3. The apparatus of claim 1, wherein the MEMS lens scanner is a two-dimensional (2D) lens scanner, and wherein the MEMS lens is configured to:
further scan the pixel array at a first group of sampling time points to obtain first image blocks; and
scan the pixel array at a second group of sampling time points to obtain second image blocks, wherein the driver is further configured to:
control the MEMS lens in a first dimension to rotate along the cantilever beam within a first angle and scan the pixel array to obtain the first image blocks; and
control the MEMS lens in a second dimension to rotate in a direction perpendicular to the cantilever beam within a second angle and scan the pixel array to obtain the second image blocks, and
wherein the first image blocks and the second image blocks form the projected image.

4. The apparatus of claim 1, wherein the pixel array comprises pixel blocks, and wherein each of the pixel blocks comprises red, green, and blue RGB subpixels that are disposed in parallel on a horizontal plane and that have a light-emitting feature.

5. The apparatus of claim 1, wherein the driver is further configured to simultaneously control the MEMS lens scanner to perform scanning of the pixel array and to drive the pixel array to perform the color display.

6. The apparatus of claim 1, wherein the pixel array comprises a surface, wherein the apparatus further comprises an optical structure disposed on the surface, and wherein the optical structure is configured to calibrate a first emitted light of the pixel array to a second emitted light featured by a narrow beam and high collimation.

7. The apparatus of claim 1, wherein the pixel array is a micro light-emitting diode (LED) display array.

8. The apparatus of claim 1, wherein a a start end of a scanning track of the MEMS lens does not extend past an utmost edge of the pixel array scanned by the MEMS lens.

9. A method comprising:
driving a pixel array having a light-emitting feature to perform color display;
controlling a micro-electro-mechanical system (MEMS) lens to rotate on a cantilever beam and scan the pixel array to obtain a projected image; and
scanning, by the MEMS lens, the pixel array.

10. The method of claim 9, wherein the MEMS lens scanner is a one-dimensional (1D) lens scanner, and wherein the method further comprises:
scanning, by the MEMS lens, the pixel array at a group of sampling time points to obtain image blocks; and
controlling the MEMS lens to rotate along the cantilever beam within an angle and scan the pixel array to obtain the image blocks, wherein the image blocks at the group of sampling points form the projected image.

11. The method of claim 9, wherein the MEMS lens scanner is a two-dimensional (2D) lens scanner, and wherein the method further comprises:
scanning, by the MEMS lens, the pixel array at a first group of sampling time points to obtain first image blocks;
scanning, by the MEMS lens, the pixel array at a second group of sampling time points to obtain second image blocks;
controlling the MEMS lens in a first dimension to rotate along the cantilever beam within a first angle and scan the pixel arrays to obtain first image blocks obtained through scanning by the MEMS lens at a group of sampling time points; and
controlling the MEMS lens in a second dimension to rotate in a direction perpendicular to the cantilever beam within a second angle and scan the pixel array to obtain the second image blocks, wherein the first image blocks and the second image blocks form the projected image.

12. The method of claim 9, further comprising simultaneously driving the pixel array to perform the color display and controlling the MEMS lens to rotate on the cantilever beam and scan the pixel array to obtain the projected image.

13. The method of claim 9, wherein a scanning track of the MEMS lens is that a start end of the scanning track does not extend an utmost edge of the pixel array scanned by the MEMS lens.

14. The apparatus of claim 1, wherein the pixel array comprises pixel blocks, and wherein each of the pixel blocks comprises red, green, and blue (RGB) subpixels that are disposed in a stacked manner in a vertical direction and that have a light-emitting feature.

15. The apparatus of claim 1, wherein the pixel array is a rectangular pixel array comprising M*N pixel blocks with M pixel blocks in each row and N pixel blocks in each column, wherein each of the M*N pixel blocks comprises red, green, and blue (RGB) subpixels, wherein the RGB subpixels have the light-emitting feature, wherein M≥1, wherein N≥1, and wherein M*N>1.

16. The apparatus of claim 1, wherein the pixel array is a circular pixel array.

17. The apparatus of claim 1, wherein the pixel array is a trapezoidal pixel array.

18. The apparatus of claim 1, wherein the pixel array is a micro organic light-emitting diode (OLED) display array.

19. An apparatus comprising:
a substrate;
a pixel array disposed on the substrate and has a light-emitting feature;
a micro-electro-mechanical system (MEMS) lens configured to scan the pixel array;
a MEMS lens scanner comprising:
a micro-electro-mechanical system (MEMS) lens configured to scan the pixel array; and
a cantilever beam disposed on the substrate and further disposed outside the pixel array and configured to fasten the MEMS lens;
a driver coupled to the pixel array and the MEMS lens scanner and configured to:
drive the pixel array to perform color display; and
control the MEMS lens to rotate on the cantilever beam and scan the pixel array to obtain a projected image; and
a lens disposed between the pixel array and the projected image and configured to advance an imaging effect of the projected image.

20. The apparatus of claim 19, wherein the pixel array is a rectangular pixel array comprising M*N pixel blocks with M pixel blocks in each row and N pixel blocks in each column, wherein each of the M*N pixel blocks comprises red, green, and blue (RGB) subpixels, wherein the RGB subpixels have the light-emitting feature, wherein M≥1, wherein N≥1, and wherein M*N>1.
